(19) United States
(12) Patent Application Publication
(10) Pub. No.: US 2002/0018015 A1
(43) Pub. Date: Feb. 14, 2002

(54) Method and means for testing the strength of vertically anchored masts

(75) Inventor: Oliver Roch, Gnissau (DE)

Correspondence Address: COHEN, PONTANI, LIEBERMAN & PAVANE, 551 Fifth Avenue, Suite 1210, New York, NY, 10176, US

(73) Assignee: Roch Prufdienste AG

(21) Appl. No.: 09/909,378

(22) Filed: Jul. 19, 2001

(30) Foreign Application Priority Data
Jul. 19, 2000 (EP) 00 115 559.7

(51) Int. Cl. G01S 5/14

(52) U.S. Cl. 342/357.13; 342/357.17

(57) ABSTRACT

With a method for testing the strength of a vertically and stationarily anchored mast the mast is mechanically loaded with bending. The behaviour of the mast occuring with this is evaluated for determining its standing and bending strength. As an adjuct to the testing procedure, the mast location is determined by way of a satellite navigation system. For this purpose the testing apparatus equipped with a GPS reciever for receiving GPS signals and a VHF receiver for recieving correction data. With this the GPS receiver and the UKW receiver form a DGPS reciever whose signals representing the location may be transferred onto a digital data memory.

### BACKGROUND OF THE INVENTION

1. Field of the Invention

The invention relates to a method for testing the strength of a standing, stationarily anchored mast in which the mast is subjected to a bending loading, and from this the behaviour of the mast for determining its strength is determined. Adjuct mast strength determination, mast location is determined and documented. Further, the invention relates to an apparatus for testing such an anchored mast, in particular a testing vehicle on which there is provided a force unit with which the bending loading may be imposed on the mast, and which vehicle includes means for receiving data documenting the behaviour of the mast with the testing procedure as well as mast location.

2. Description of the Related Art

With methods and means of this type (EP 0 638 794 B1, WO 97/40355) it is particularly the case that the testing of the standing and bending strength of masts carrying lamps, of lighting-up installations, but also of masts carrying signals, traffic signs and likewise, which are for example operated by communities, energy suppliers and cities also can be tested.

If to a company assigned with the testing of masts there is made available by the operator map information, there basically exists the possibility of drawing in the locations of the masts to be tested or which have been tested onto a map representing a certain city district in which the masts are set up. At the same time, with regard to the allocation of the respective mast locations, such will be orientated with house numbers, street crossings, street names and building locations. At present, masts along a street are even numbered after one another.

Notwithstanding the considereable expense which this entails, in the course of time there are often changes of the course of roads and of the previously mentioned orientation features as well as exchanges and renewed setting up of masts, which with the multitude of mast systems present can lead to a loss of oversight in the case that the map material present with the entered mast locations are not constanty updated by the operator. While not common, loss of oversight does occur.

For this reason very many operators of lighting installations have no overview of their mast systems. By way of this the maintenance and upkeeping is made more difficult and uneconomical or even impossible. An economical and also safety-conscious planning presumes that the operator of such installations and systems has an exact knowledge of the condition and location of the masts.

### SUMMARY OF THE INVENTION

The present invention has as an object to overcome the above indicated problems, and provides a method and apparatus with which in the course of a standing safety test of masts, in a reliable manner, the location of the respective mast may be exactly determined as well as simply documented.

In achieving this object and in real time context, i.e., as an adjunct procedure to the testing procedure, the mast location is determined and documented by way of a satellite navigation system. In particular this is effected by the use of GPS (Global Positioning System) and of the even more exactly functioning DGPS (Differential GPS) as a navigation system, since the DGPS measuring accuracy with regard to location coordinates lies in the range of centimetres.

Different from known navigation systems (DE 41 36 136 C1, EP 0 574 009 A2, EP 0 847 537 B1, U.S. Pat. No. 5,422,813 and U.S. Pat. No. 5,477,228), with the system being applied according to the invention it is not a question of location determination of movable objects and also not a question of use of a navigation system for navigating course movement of an object but it is a matter of determining stationary mast locations, which may be effected before, during or after the strength testing of the respective mast.

In particular the coordinates of the mast location are recorded and documented cartographically in that, for example, the location of the mast in the form of a symbol is transmitted onto a digital map. Also for different mast types there may be provided suitable symbols and these transmitted to such maps.

Furthermore there exists the possibility of setting up a data bank from digitalizd location data of several masts and from the digital map, said data bank being made available by the testing company to the operator of the mast systems. Usefully the data bank is applied in combination with testing software so that it also receives data of the respective mast testing results; and the operator may not only determine where the masts concerned stand but also which masts where appropriate with the testing procedure are determined as being insufficiently stable.

The testing software thus combines the coordinates of a mast with the results of the standing safety test so that there arises a homogeneous set of data which is stored in the data bank and then by way of a geo-information system may be represented in suitable geo-referenced digital maps. By way of this it is of course additionally possible via the map to directly call up data which has been read in.

The initially mentioned means for testing masts is characterized in that for the purpose of determining the mast location the testing apparatus is equipped with a GPS receiver (Global Positioning System) for receiving GPS signals and a VHF receiver for receiving correction data on RDS signals (Radio Data Sytems). The GPS receiver and the VHF receiver form a DGPS receiver (Digital GPS) whose signals representing the location of the mast are transmittable to a digital data memory. This memory may be a notebook, a PC or an organiser.

Mostly mobile testing apparatus, such as testing vehicles and units are equipped with an adjustable extension arm which at the free end is equipped with a sleeve for gripping round the mast. In such cases the GPS antenna should be releasably arranged in the direct vicinity of the extension arm end carrying the sleeve, at the closest possible distance to the mast encompassed by the sleeve in order to be able to have an exact as possible dermination of the coordinates of the mast location.

It is useful to carry out the location determination before the testing of the standing strength of the mast, since it may happen that a defective mast could plastically deform during the testing procedure and then an exact location determination may no longer be possible.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a schematic showing of one embodiment of the invention.

### DETAILED DESCRIPTION OF THE PRESENTLY PREFERRED EMBODIMENTS

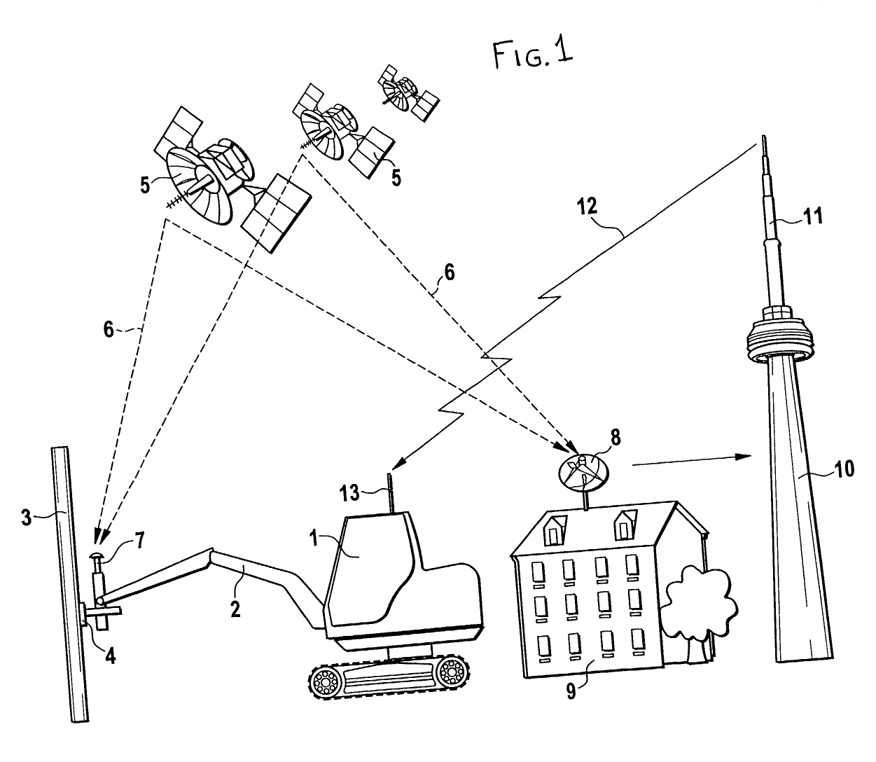

Reference to FIG. 1 the testing apparatus is a mobile testing vehicle 1 with a multi-armed extension arm 2 which with a stationary vehicle is movable towards a mast 3 to be tested and according to the testing method reversely movable, and specifically with a sleeve 4 attached to the free end of the extension arm 3 and applied around the mast 3. Details of the testing procedure as well as the determining of readings concerning the mast strength are known and therefore do not need to be described any further. Inasmuch as this is concerned amongst others the already cited documents EP 0 638 794 B1 and WO 97/40355 are referred to.

GPS signals 6 which come from satellites 5 and which are captured by GPS antennae 7 allocated to the testing vehicle reach a GPS receiver, which is not shown further, in or on the testing vehicle 1. The same GPS signals are likewise received by a GPS antenna 8 of a stationary and exactly measured reference station 9 which from the up-to-date GPS signals determines their “location” and with deviations from their actual location computes correction data and transmits these via radio to a VHF radio station 10 represented schematically by a transmission mast.

From the transmitting antenna 11 of this station the correction data together with the usual RDS signals 12 containing further information data are beamed away and received by a VHF antenna 13 of a VHF tuner, installed on the testing vehicle.

This tuner together with the GPS reciever forms a DGPS reciever, thus a differential-GPS receiver which on account of correction data, also called difference signals, separated from the RDS signal with a decoder, permits a high accuracy with regard to determining the coordinates of the mast location. Further details of this technology known per se are to be deduced amongst other things from the already cited documents DE 41 36 136 C1, EP 0 574 008 A2 and U.S. Pat. No. 5,477,228.

As has been noted above, the respective determined data for the coordinates of the mast location and the strength readings ascertained with the testing procedure are stored in digital form in a data memory which may be a notebook with a connected monitor, located in the testing vehicle, on which the data may be represented in tabular form or also the digitalised map with the respective mast location may be represented. The data bank with the associated software may be allocated to an external computer which may be located at the seat of the company carrying out the mast testing and to which the data to be recorded into the data bank may be led via radio. Finally, to the computer there may be connected output apparatus such as monitors, printers and likewise to which the values stored in the data bank may be supplied using suitable software.

The invention is not limited by the embodiments described above which are presented as examples only but can be modified in various ways within the scope of protection defined by the appended patent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for testing the strength of a vertically and stationarily anchored mast, comprising:
subjecting the mast to a mechanically imposed bending load;
evaluating the behavior of the mast while under said bending load to determine the strength of said mast; and
determining and documenting a location of the mast with a satellite navigation system as an adjuct to determining the strength of said mast.

2. The method according to claim 1, wherein the navigation system is a Global Positioning System.

3. The method according to claim 3, wherein the navigation system is a Differential Global Positioning System.

4. The method according to claim 1, further comprising recording and cartographically documenting coordinates of the mast location.

5. The method according to claim 1, further comprising transmitting mast location in the form of a symbol onto a digital map.

6. The method according to claim 6, including setting up a data bank using digitalized mast location data of a number of masts and data from the digital map.

7. The method according to claim 7, including utilizing the data bank in combination with testing software containing digitalized data of mast test results.

8. The method according to claim 1, including determining the mast location before subjecting the mast to the bending load.

9. In a method for testing the strength of a vertically and stationarily anchored mast which comprises subjecting the mast to a mechanically imposed bending load, and evaluating the behavior of the mast while under said bending load to determine the strength of said mast, the improvement comprising:
determining and documenting a location of the mast with a satellite navigation system as an adjunct to the mast strength testing.

10. Apparatus for testing the strength of a vertically and stationarily anchored mast, comprising:
a mobile testing unit;
a force unit on said mobile testing unit for imposing a bending load on said mast;
means for receiving data documenting mast behavior with a testing procedure;
a Global Positioning System receiver on said mobile testing unit for receiving Global Positioning System signals;
a VHF receiver on said mobile testing unit for receiving correction data, said Global Positioning System receiver and said VHF receiver together comprising a Digital Global Position receiver receiving signals representing mast location so that said mast location signals can be transmitted to a digital data memory.

11. Apparatus according to claim 10, further comprising an adjustable extension arm carried on said mobile testing unit, said extension arm having a tip end, a sleeve for encompassing said mast carried on said extension arm tip end, and a Global Positioning System antenna releasably arranged proximal said extension arm tip end.
